(19) United States
(12) Patent Application Publication
(10) Pub. No.: US 2006/0115381 A1
(43) Pub. Date: Jun. 1, 2006

(54) Solution mixing device and analysis system

(76) Inventors: Norihito Kuno, Tsurugashima (JP); Masayoshi Ishibashi, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/195,665

(22) Filed: Aug. 3, 2005

(30) Foreign Application Priority Data
Dec. 1, 2004 (JP) 2004-347986

(51) Int. Cl. B01L 3/00

(52) U.S. Cl. 422/100

(57) ABSTRACT

An analyzer to carry out a reaction with efficiency is provided. A substrate and a cover member having a concave portion to form a space for retaining a reaction solution are constructed of deformable material, the cover member is deformed by exerting a force externally of the cover member, and the reaction solution introduced into the space for reaction is moved within the space by this deformation, thereby allowing the reaction solution to be stirred within the space. Enhancement of signal intensities is achieved by improvement of reaction efficiency due to mixing. Further, uniform mixing can be achieved over the entire region within the space because an arbitrary location of the cover member can be deformed.

### CLAIM OF PRIORITY

The present application claims priority from Japanese application JP 2004-347986 filed on Dec. 1, 2004, the content of which is hereby incorporated by reference into this application.

### FIELD OF THE INVENTION

The present invention relates to an analyzer and a detection system in which a reaction solution containing at least a molecule that interacts with at least a biomolecule or at least a tissue section containing the biomolecule fixed on a substrate is stirred in a reaction space.

### BACKGROUND OF THE INVENTION

In the field of current molecular biology, attention is focused on expression analysis and functional analysis of genes and proteins as an important task. To perform this analysis, DNA chip, DNA microarray, protein array, tissue microarray, and the like that are immobilized with nucleic acids, proteins, or tissue sections on a slide glass substrate have come into widespread use. In order to carry out a reaction such as hybridization or antigen-antibody reaction on the slide glass substrate, it is generally necessary to cover the substrate with cover glass or to keep it in a wet chamber or in a closed container for prevention of evaporation of a reaction solution during a reaction requiring a long time (more than 12 hours) after dropping the reaction solution containing a nucleic acid probe or antibody on the substrate. Since mixing the reaction solution is effective for shortening the reaction time, enhancing sensitivity in signal detection, and enhancing reproducibility of detection signal, a reaction vessel or apparatus provided with mixing function is used.

As a conventional apparatus, for example, as disclosed in Patent Document 1 (U.S. Pat. No. 6,238,910), a hybridization apparatus for DNA microarray in which hybridization reactivity is improved by carrying out reciprocal shaking of a reaction solution in a reaction vessel by means of an installed pump function is described.

In Patent Document 2 (U.S. Patent Application No. 20040115097), a method in which surface acoustic waves stimulated on the surface of a piezoelectric solids by surface distortion of the piezoelectric body arising from application of an electric field to interdigital electrodes deposited on the piezoelectric solids is utilized for mixing of a small quantity of liquid is disclosed.

Further, in Patent Document 3 (JP-A No. 248008/2003), a method in which mixing of a reaction solution in a micro-reaction vessel is carried out by allowing magnetic beads to be present in the reaction solution in the micro-reaction vessel and providing the magnetic beads with magnetic changes externally to fluidize them in the reaction vessel.

Since efficiency of hybridization is improved in a reaction apparatus of conventional technology having a function of mixing of a reaction solution compared with a case in which mixing is not performed, it is considered that mixing of a reaction solution by the conventional technology is an effective technique. However, when reciprocal shaking of a reaction solution is carried out by a pumping function provided to the apparatus, an extra volume of the reaction solution corresponding to the solution retained in the volume of syringe pump and that of a flow path between the pump and the reaction vessel is required in addition to the volume of the solution retained in the reaction vessel on the slide glass substrate, resulting in wasting a sample or probe contained in the reaction solution. Further, it is necessary to arrange a flow path connecting the pump to the reaction vessel, thereby making the mechanism of the apparatus more complicated.

On the other hand, in the method disclosed in Patent Document 2 in which the flow path to connect a pump portion for mixing a reaction solution to the reaction vessel is not required, vibration amplitude of the surface acoustic wave utilized for mixing the solution is only several nanometers and very small, and therefore a region in which mixing can be performed is limited in the depth direction of the reaction vessel. Further, not only is the surface sound wave very weak but also its traveling direction is limited to the direction perpendicular to the interdigital electrodes, and thus arrangement of a plurality of surface acoustic wave-generating portions is required to stir and mix uniformly the whole region on the slide glass substrate, resulting in making the mechanism of the apparatus more complicated.

In the technique disclosed in Patent Document 3 described above, magnetic beads are moved toward the upper side of the micro-reaction vessel (the inside of the cover), and therefore liquid movement caused by the movement of the beads is satisfactory in the upper side of the micro-reaction vessel, whereas liquid movement, that is, mixing efficiency of the liquid in the lower side of the vessel near the surface of the slide glass substrate is decreased. Furthermore, contact of the magnetic beads with the slide glass substrate in the micro-reaction vessel detaches fixed nucleic acid, protein, or tissue section from the substrate, and the possibility that intensities of signals to be detected are influenced cannot be denied.

### SUMMARY OF THE INVENTION

An object of the present invention is to provide an analyzer and a detection system that do not need a complicated device mechanism, achieve a uniform mixing of a reaction solution over an entire region on a slide glass substrate, and have a way of mixing that gives high reaction efficiency.

An apparatus characterized in that a substrate holder to hold a substrate where at least part of the surface is fixed with at least a substance that binds specifically to at least a target analyte, a cover member that faces the substrate holder and covers the substrate, a liquid inlet to introduce a liquid between the substrate and the cover member, a liquid outlet to discharge the liquid introduced between the substrate and the cover member, and an actuating unit that makes contact with the cover member are provided and the actuating unit deforms at least part of the cover member is provided. Here, the cover member may have a concave portion facing the substrate and make contact with the actuating unit on its surface not facing the substrate. The material for the cover member is desirably a material having elasticity. Specifically, it may be rubber such as synthetic rubber and elastic rubber or a material classified as elastomer. The present apparatus may be used either as a solution mixing type apparatus or an analysis system equipped with a detection system.

Using as another construction an apparatus having a substrate holder to hold a substrate where at least part of the surface is fixed with at least a probe or at least a tissue section that binds selectively to at least a target analyte in a sample solution, a cover member that has a concave portion so as to face the substrate holder and form a space to retain a solution on the surface of the probe or the tissue section fixed on the substrate and covers the substrate, a liquid inlet to introduce a liquid into the space formed between the substrate and the cover member, a liquid outlet to discharge the liquid introduced into the space formed between the substrate and the cover member, and an actuating unit that makes contact with the cover member and exerts a force on the cover member externally, mixing of the solution retained in the space may be carried out by deforming at least part of the cover member by the actuating unit.

According to the above construction, it becomes possible to stir the solution retained in the space under various conditions by deforming an arbitrary place of the deformable cover member with an arbitrary force and in an arbitrary number of times and magnitude of movement. This mixing allows uniform mixing of the reaction solution to be accomplished over the entire region on the slide glass substrate, and high reaction efficiency is also obtained. It should be mentioned that even when the volume of the solution retained in the space is small, not only can uniform mixing be accomplished but also uniformity in reaction efficiency can be obtained by the above construction.

Further, an increase in the number of reaction processing of target analyte is achieved by providing a plurality of the concave portions on the cover member to form reaction spaces and mixing each of the reaction spaces via deformation of the cover member.

Furthermore, it becomes possible to detect reaction signals continuously or concurrently with the reaction by providing a window portion on the substrate holder as well as a detection unit to detect the reaction with the target analyte. Owing to a short time between a reaction and its detection, the number of analyzable target analyte can be increased.

According to the present invention, there is an effect of enhancing signal intensities due to an improvement in reaction efficiency by mixing in the reaction space a solution containing at least a molecule interacting with at least a biomolecule fixed on a substrate or the biomolecule localized on at least a tissue section fixed thereon. Even when a plurality of the reaction spaces may be provided and the number or the kind of test samples may differ, there is also an effect that reactions can be run at the same time.

### BRIEF DESCRIPTION OF THE DRAWINGS

FIG. 1 is a diagram showing a structure of a solution mixing type analyzer of a first embodiment of the present invention, where FIG. 1A is a plan view, FIG. 1B is a cross sectional view, and the FIG. 1C is another cross sectional view;

FIG. 2 is a diagram showing how to stir a solution in a space by deformation of a cover member in the solution mixing type analyzer of the first embodiment of the present invention, where FIG. 2A is a plan view, FIG. 2B is a cross sectional view, FIG. 2C is another cross sectional view, and FIG. 2D is said another cross sectional view in a different state;

FIG. 3 represents an example of results obtained from performing immunohistochemical staining with a monoclonal antibody after setting a slide glass fixed with tissue sections on the solution mixing type analyzer of the first embodiment of the present invention;

FIG. 4 is a diagram explaining approximate locations of the tissue sections subjected to immunohistochemical staining on the slide glass in the first embodiment of the present invention;

FIG. 5 is a diagram showing how to stir with an actuating unit having a curved shape in the solution mixing type analyzer of the first embodiment of the present invention, where FIG. 5A shows a structure of the actuating unit, FIG. 5B is a cross sectional view, FIG. 5C is another cross sectional view, and FIG. 5D is still another cross sectional view;

FIG. 6 is a diagram showing a structure provided with an actuator as the actuating unit in the solution mixing type analyzer of the first embodiment of the present invention, where FIG. 6A is a plan view, FIG. 6B is a cross sectional view, and FIG. 6C is the cross sectional view in a different state;

FIG. 7 is a diagram showing how to stir the solution in the space by deforming the cover member with the use of change of magnetism as actuation means in the solution mixing type analyzer of the first embodiment of the present invention, where FIG. 7A is a plan view, FIG. 7B is a cross sectional view, and FIG. 7C is the cross sectional view in a different state;

FIG. 8 is a diagram showing an arrangement of a plurality of concave portions formed on the cover member in the solution mixing type analyzer of the first embodiment of the present invention, where FIG. 8A is a plan view and FIG. 8B is a cross sectional view;

FIG. 9 is a diagram showing a structure of a solution mixing type analysis system provided with a detection unit to detect a reaction with a target analyte representing a second embodiment of the present invention, where FIG. 9A is a plan view, FIG. 9B is a cross sectional view, and FIG. 9C is another cross sectional view;

FIG. 10 is a diagram showing a structure to actuate the actuating unit with the use of a motor and a slider-crank mechanism in the first embodiment of the present invention; and

FIG. 11 is a diagram showing a structure of hard rubber attached with a small vibrating motor for the actuating unit.

### DETAILED DESCRIPTION OF THE PREFERRED EMBODIMENTS

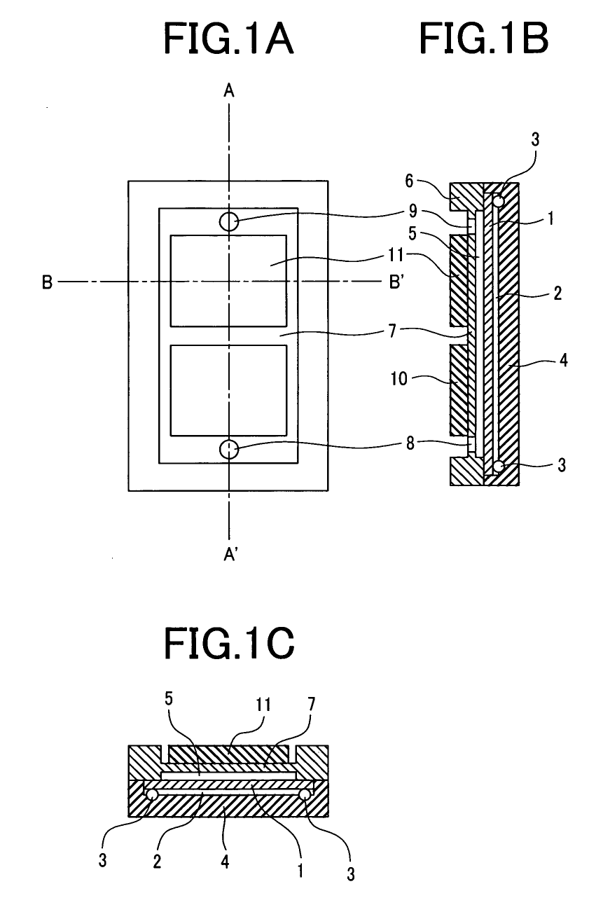

Hereinafter, embodiments of the present invention are explained referring to FIG. 1.

### First Embodiment

The construction of an analyzer according to the present invention is shown in FIG. 1A to 1C. Here, FIG. 1A is a plan view, FIG. 1B is a cross sectional view along the line A-A′, and the FIG. 1C is a cross sectional view along the line B-B′ of the analyzer. The analyzer is constructed from a substrate holder 4 that is formed with a concave portion 2 to hold a substrate 1 where at least part of the surface is fixed with at lest a probe or at least a tissue section that binds selectively to at least a target analyte in a sample solution and O-rings 3, a cover member 7 that has a concave portion 6 so as to face the substrate holder 4 and form a space 5 to retain a solution on the probe or the tissue section fixed on the surface of the substrate 1 and covers the substrate 1, a liquid inlet 8 to introduce a liquid into the space 5 formed between the substrate 1 and the cover member 7, a liquid outlet 9 to discharge the liquid introduced into the space 5, and actuating units 10 and 11 that make contacts with the cover member 7 and exert a force on the cover member externally. Here, the substrate holder 4 and the cover member 7 form a combined body by a connecting member not shown. The cover member is made of a material deformable by a force applied externally, and the material includes synthetic rubber, elastic rubber (natural rubber), or a material containing them. As the synthetic rubber, butadiene-styrene rubber, butyl rubber, nitrile rubber, chloroprene rubber, urethane rubber, fluorine rubber, silicone rubber, and the like can be used. As the elastic rubber, latex rubber and the like can be used. Among them, silicone rubber and polydimethylsiloxane (PDMS) that is a kind of the former is particularly desirable because of low reactivity to biomaterials and easy formability. In addition, the material for the cover member may make use of a substance classified as elastomer. An elastomer is an elastic body having an elongation percentage equal to or higher than 100% and a remarkably elastic polymer that is readily deformed by an external force and restored to its original shape upon releasing the external force. As the elastomer, a general silicone elastomer that has —Si—O—Si— bond in its molecule and is cured into rubber-like material by adding a curing catalyst such as a peroxide or a platinum compound or by partial crystallization can be used.

The height of the space 5 formed between the substrate 1 and the cover member 7 that has a concave portion 6 so as to face the substrate holder 4 and form the space 5 to retain a solution on the probe or the tissue section fixed on the surface of the substrate 1 and covers the substrate 1 as shown in FIGS. 1B and 1C, that is, the distance between the surface of the concave portion facing the substrate and the substrate is preferably larger than about 0.02 mm and smaller than about 1.00 mm from the surface of the substrate 1. When the height of the space 5 is smaller than 0.02 mm, it becomes difficult to control the magnitude of deformation by the actuating unit in order to secure the space 5 as well as deform at least part of the cover member 7 by the actuating unit. On the other hand, when the height of the space 5 is larger than 1 mm, the volume of the solution becomes too large, and the efficiency of the solution mixing method of the present invention by means of deforming at least part of the cover member 7 is decreased.

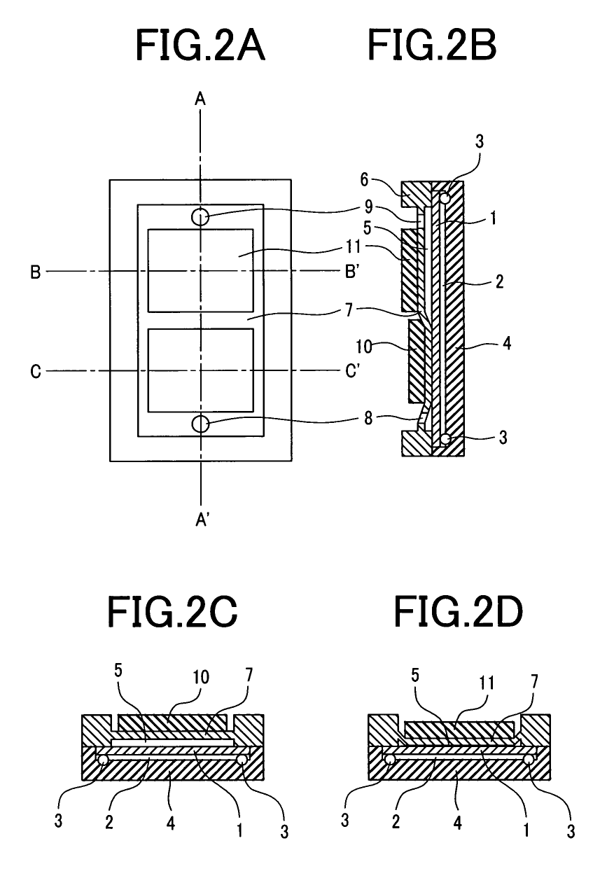

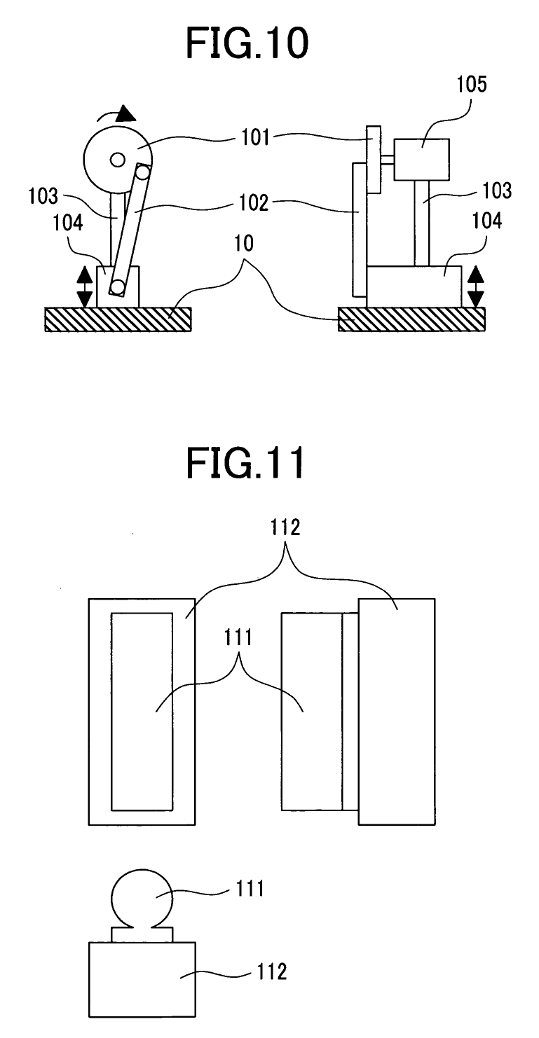

In order to stir the solution in the space 5, the actuating units 10 and 11 that make contacts with the cover member 7 and exert an external force on the cover member are used as shown in FIG. 2B, 2C, or 2D. Specifically, mixing is carried out by actuating the actuating units 10 and 11 and deforming the cover member 7. An example of the actuation method that makes use of a motor and a slider-crank mechanism is shown in FIG. 10. A crank (circular) 101 is rotated by a motor 105, and an actuator 104 is moved up and down through a link 102. The actuating unit 10 is actuated by the up and down movements. A guide 103 arranged so as to penetrate the actuator 104 is linked and fixed, together with the motor 105, to a connecting member not shown. In FIG. 2, a case in which the actuating units 10 and 11 are independently moved up and down is shown. When each of the actuating units 10 and 11 is actuated with the use of the slider-crank mechanism shown in FIG. 10 as an example, it is possible to control differently the timing of movement of the respective actuators 10 and 11 as shown in FIG. 2, that is, the timing of deforming the cover member 7 with each actuator by means of rotating the motor 105 while arranging the positions of the cranks 101 of the actuating units 10 and 11 to different positions. By repeating this up and down movement of the actuating units 10 and 11, mixing of the solution in the space 5 can be achieved. The speed and the number of the up and down movement can be arbitrarily set, and for example, the movement about once every second may be sufficient.

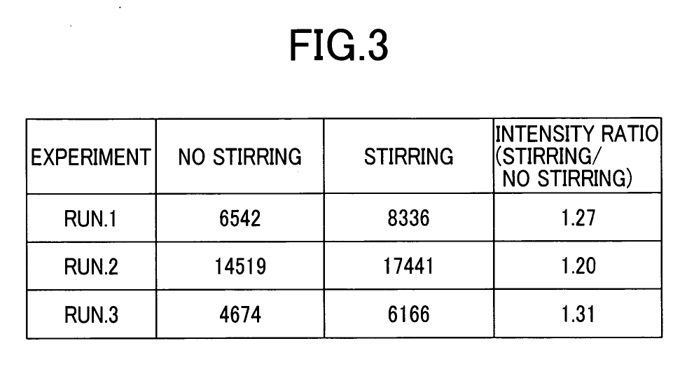

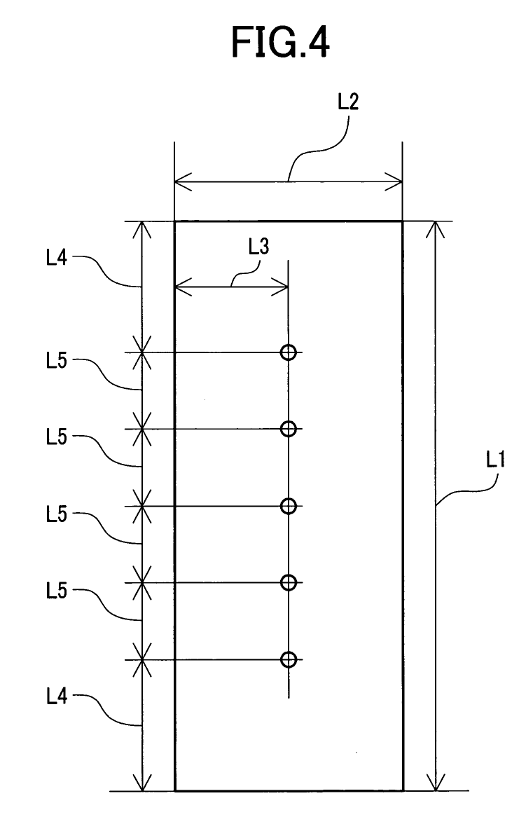

With the use of the analyzer according to the present invention, an example of the results obtained from performing immunohistochemical staining with a monoclonal antibody is shown in FIG. 3. Five pieces of resin-embedded tissue sections of paroctopus retina (thickness; one micrometer) after fixing with 4% paraformaldehyde were pasted at positions on a slide glass shown in FIG. 4. In FIG. 4, each dimension was as follows: L1=75 mm, L2=22 mm, L3=11 mm, L4=10.25 mm, and L5=9 mm. These tissue sections were treated with a phosphate buffer solution for one min, followed by blocking for 10 min. The slide glass after this blocking was placed between the cover member made of polydimethylsiloxane (PDMS) that is a kind of silicon rubber (silicone elastomer) and the substrate holder made of aluminum, and a space to hold a reaction solution was formed between the slide glass and the cover member. It should be noted that a concave portion having a depth of 0.5 mm was formed on the surface of the cover member facing the slide glass. As a reaction solution, a phosphate buffer solution containing an anti-octopus rhodopsin monoclonal antibody (5,000-fold dilution) was introduced into the reaction space from the liquid inlet. Two actuating units in each of which a small vibrating motor 111 (Model CM05J, product of TPC) was attached to hard rubber 112 were used as shown in FIG. 11. The two pieces of the hard rubber attached with the small vibrating motor shown in FIG. 11 were placed at positions similar to those of the actuating units 10 and 11 shown in FIG. 1, and mixing was carried out by driving the small vibrating motors for 30 min by a power source. At this time, the distance of the up and down movement of the hard rubber attached with the small vibrating motor was set to about 0.1 mm. As a control, the analyzer left standing for 30 min without mixing by the small vibrating motor was used. After the reaction, the slide glass was taken out, washed with a phosphate buffer solution containing 0.05% Tween 20 three times for 5 min, and then a secondary antibody (anti-mouse IgG antibody labeled with an alkaline phosphatase, product of Promega) was reacted for one hour. After washing with the phosphate buffer solution containing 0.05% Tween 20 three times for 5 min, the ECL luminescent substrate (CDP-Star detection reagent, product of Amersham) was reacted for one hour, and then chemiluminescent signals from the sample were measured with a Luminoimage analyzer LAS-1000 (product of Fuji Film). The signal intensities from each of the five pieces of the sections were measured, and the results of the average intensities calculated for each slide glass are shown in FIG. 3. When mixing was carried out, the signal intensities were enhanced by 20 to 30% on average compared to those without mixing (control), and thus an increase in reaction efficiency by mixing was confirmed. Although the distance of the up and down movement of the hard rubber attached with the small vibrating motor was about 0.1 mm and the thickness of the reaction space was 0.5 mm, a sufficient effect of mixing was obtained.

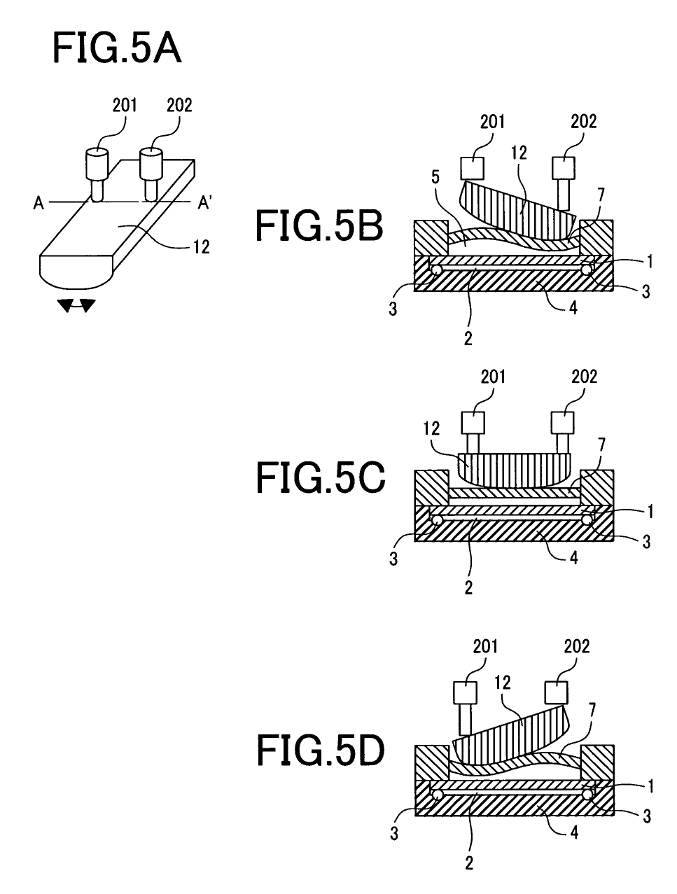

Next, another example of the actuating unit shown in FIG. 2 is shown in FIG. 5. FIG. 5A shows a structure of an actuating unit 12 in which the shape of the contact surface with the cover member is curved. In FIGS. 5B to 5D, how to stir is shown when viewed from the cross section along the line A-A′ in FIG. 5A, where the way to stir a solution in the space 5 by rocking the actuating unit 12 with the use of actuators 201 and 202 is shown as an example. Rocking of the actuating unit 12 shown in FIG. 5 is performed by allowing the actuators 201 and 202 shown in FIG. 5 to come in contact with the actuating unit 12 alternately and exert a force on the actuating unit. In this way, a result similar to that in FIG. 1 was obtained, and the efficiency of moving and mixing the solution in the space 5 was enhanced by deforming the whole surface of the cover member.

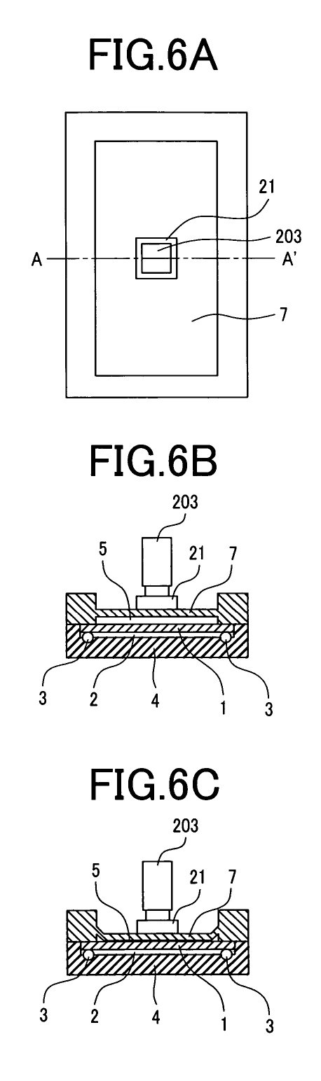

FIG. 6A shows still another example, and FIGS. 6B and 6C viewed from the cross section along the line A-A′ show that the actuating unit 21 in a flat plate-like form is actuated by an actuator 203. In FIG. 6A, a case in which one actuator deforms the cover member at its center is shown as an example, but the number of the actuator to be arranged and the location of the actuator to be arranged on the cover member can be arbitrarily set. Further, the timing of the actuator to contact the cover member for deforming can be arbitrarily set. In this way, a result similar to that in FIG. 1 was obtained, and the efficiency of mixing was enhanced by arranging a plurality of the actuators and thus achieving deformation over the whole cover member.

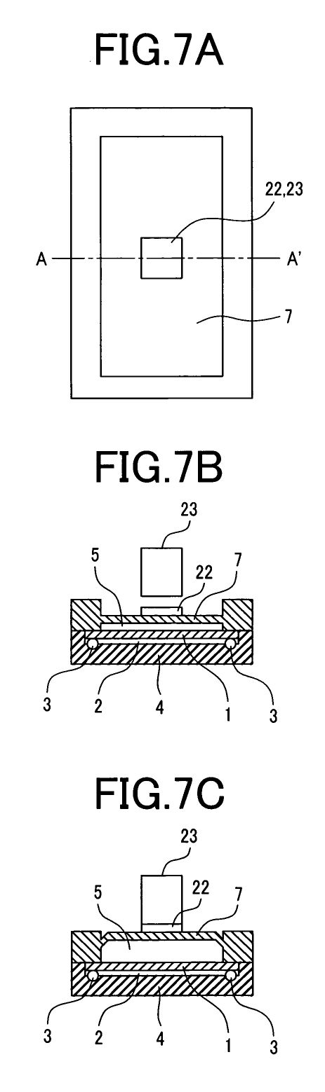

FIG. 7A shows still another example where change of magnetic field is employed as actuation means. FIGS. 7B and 7C show appearances of the actuating unit in the cross section along the line A-A′. A member 22 made of metals having a property of magnetic sensitivity, i.e. susceptibility to magnetic influence, such as iron, a resin partially containing them, or the like is attached to an arbitrary location on the surface of the cover member not facing the substrate, and this member 22 is moved by an external change of the magnetic field, thereby deforming the cover member 7. In changing the magnetic field, for example, the member 22 is moved upward by making use of an attractive force that is generated by magnetizing a magnetic field-changing unit arranged in the vicinity of the member 22 susceptible to magnetic influence, specifically an electromagnet 23, from a non-magnetized state shown in FIG. 7B. The cover member 7 attached with the member 22 is deformed concurrently with the movement of this member 22. It is also possible to move the member 22 by using a permanent magnet in place of the electromagnet 23 and moving the permanent magnet. In FIG. 7, a case in which one electromagnet deforms the cover member at its center is shown as an example, but the number of the electromagnet to be arranged and the location of the electromagnet to be arranged on the cover member can be arbitrarily set. Further, the number of the member 22 susceptible to the influence of the electromagnet and the location of the member 22 to be arranged may also be set according to the number and the location of the electromagnet arranged. In this way, a result similar to that in FIG. 1 was obtained, and the efficiency of mixing was enhanced by arranging a plurality of the electromagnets and thus achieving deformation over the whole cover member.

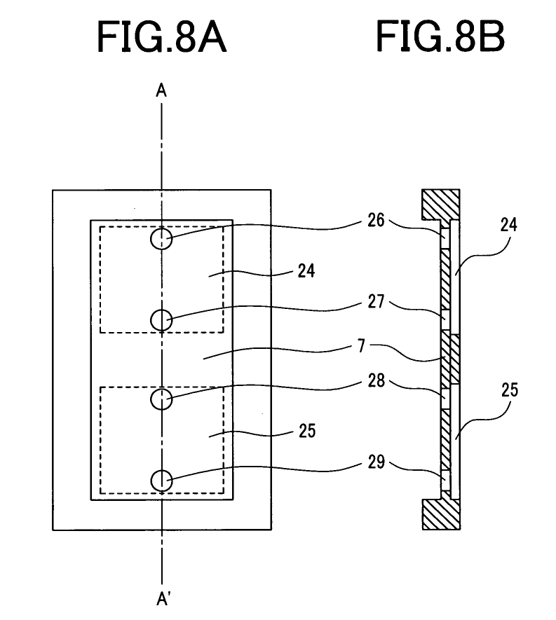

FIGS. 8A and 8B are diagrams explaining another structure of the concave portion 2 of the cover member 7 shown in FIG. 1. FIG. 8 represents a case where two concave portions 24 and 25 are arranged on the cover member 7. Further, liquid inlets 26 and 28 and liquid outlets 27 and 29 are provided to respective concave portions. In this way, different spaces to keep different reaction solutions are formed, and different reactions can be performed at the same time. Although FIG. 8 shows a case where two concave portions are formed on the cover member as an example, the number of the concave portion and its location on the cover member can be arbitrarily set. In this way, a result similar to that in FIG. 1 can be obtained, and processing capacity was enhanced by pluralizing the concave portions.

### Second Embodiment

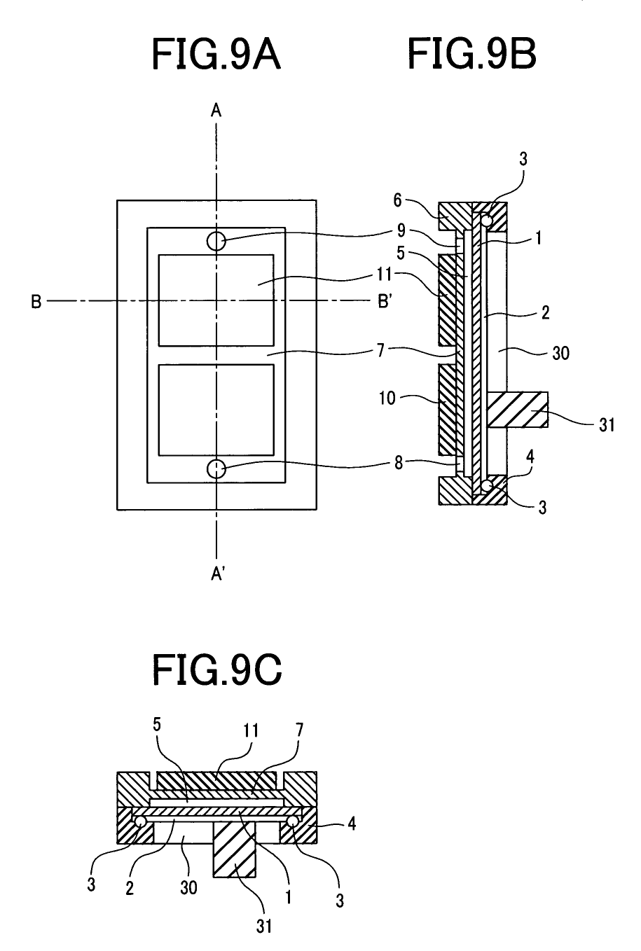

FIG. 9 represents a second embodiment of the present invention and is an illustration corresponding to FIGS. 1A, 1B, and 1C that shows a structure of a detection system composed of at least a probe or at least a tissue section fixed on a substrate and a solution mixing type analyzer provided with a detection unit to detect a reaction with a target analyte in a sample solution. On the substrate holder 4, a window portion 30 is provided inside the O-rings 3 present for holding the substrate 1. A detection unit 31 to detect reaction signals is placed on the surface of the window portion facing the surface of the retained substrate 1. The detection unit 31 can be moved to any arbitrary position in the window portion 30 and is able to detect reaction signals over the whole substrate 1. The detection unit 31 is constructed from a camera or a microscope that can detect fluorescence, chemiluminescence, and color development. It is possible to detect a reaction continuously or concomitantly with the reaction by providing the detection unit capable of detecting the reaction with a target analyte, and therefore it becomes possible to analyze real-time changes occurring in the reaction. Further, the reaction and its detection can be preformed in a short time, thereby enabling to increase the number of target analyte that can be analyzed.

The present invention may also take the following constructions:

(1) An analyzer characterized in that a substrate holder to hold a substrate where at least part of the surface is fixed with at least a probe or at least a tissue section that binds selectively to at least a target analyte in a sample solution, a cover member that has a concave portion so as to face the substrate holder and form a space to retain a solution on the surface of the probe or the tissue section fixed on the substrate and covers the substrate, a liquid inlet to introduce a liquid into the space formed between the substrate and the cover member, a liquid outlet to discharge the liquid introduced into the space formed between the substrate and the cover member, and an actuating unit that makes contact with the cover member and exerts a force on the cover member externally are provided, and mixing of the solution retained in the space is carried out by deforming at least part of the cover member by the actuating unit.

(2) The solution mixing type analyzer described in (1) characterized in that the concave portion faces the surface of the substrate on which the probe or tissue section is fixed, and the actuating unit makes contact with an arbitrary location on the surface of the concave portion not facing the substrate and deforms the cover member.

(3) The solution mixing type analyzer described in (1) characterized in that a motor or actuator is provided as the actuating unit.

(4) The solution mixing type analyzer described in (1) characterized in that a member susceptible to magnetic influence is attached to an arbitrary location on the surface of the concave portion not facing the substrate as the actuating unit, and the cover member is deformed by moving the member susceptible to magnetic influence through a change of magnetic field externally.

(5) The solution mixing type analyzer described in (4) characterized in that the change of magnetic field is performed by moving a permanent magnet arranged in the vicinity of the member susceptible to magnetic influence or by magnetizing and de-magnetizing an electromagnet.

(6) The solution mixing type analyzer described in (1) characterized in that the thickness of the space formed between the substrate and the concave portion provided on the cover member is from 20 micrometers to one millimeter.

(7) The solution mixing type analyzer described in (1) characterized in that the magnitude of deformation of the cover member by the actuating unit is in the range from at least 20% to less than 100% of the thickness of the space.

(8) The solution mixing type analyzer described in (1) characterized in that a plurality of the concave portions are provided on the cover member in order to form a plurality of spaces between the substrate and the concave portion provided on the cover member.

(9) The solution mixing type analyzer described in (8) characterized in that, for the cover member having a plurality of the concave portions, the cover member on each concave portion is deformed by the actuating units that make contacts independently with the surfaces of each concave portion not facing the substrate.

(10) The solution mixing type analyzer described in (1) characterized in that the cover member is made of a flexible and deformable resin material which can be quickly deformed in response to the shape of the actuating unit, the magnitude of its movement, the speed of its movement, and the like, and is preferably a silicone resin, an elastomer containing silicone, or a silicone rubber, and mixing of the solution retained in the space is carried out by deformation by the actuating unit.

(11) The solution mixing type analyzer described in (1) characterized in that the target analyte is a single strand or double strand nucleic acid, antibody, antigen, receptor, ligand, or enzyme when the probe fixed on the substrate is a nucleic acid probe, antigen, antibody, ligand, receptor, or substrate, or the target analyte is a single strand nucleic acid or antibody when the tissue section is fixed on the substrate.

(12) A detection system characterized in that a substrate holder to hold a substrate where at least part of the surface is fixed with at least a probe or at least a tissue section that binds selectively to at least a target analyte in a sample solution, a cover member that has a concave portion so as to face the substrate holder and form a space to retain a solution on the surface of the probe or the tissue section fixed on the substrate and covers the substrate, a liquid inlet to introduce a liquid into the space formed between the substrate and the cover member, a liquid outlet to discharge the liquid introduced into the space formed between the substrate and the cover member, a detection unit to detect a reaction between the fixed probe or tissue section and the target analyte in the sample solution, and an actuating unit that makes contact with the cover member and exerts a force on the cover member externally are provided, and mixing of the solution retained in the space is carried out by deforming at least part of the cover member by the actuating unit.

(13) The detection system described in (12) characterized in that the substrate holder has a window portion, and the detection unit detects the reaction through the window portion.

(14) The detection system described in (12) characterized in that the concave portion faces the surface of the substrate on which the probe or tissue section is fixed, and the actuating unit makes contact with an arbitrary location on the surface of the concave portion not facing the substrate and deforms the cover member.

(15) The detection system described in (12) characterized in that a motor or actuator is provided as the actuating unit.

(16) The detection system described in (12) characterized in that a member susceptible to magnetic influence is attached to an arbitrary location on the surface of the concave portion not facing the substrate as the actuating unit, and the cover member is deformed by moving the member susceptible to magnetic influence through a change of magnetic field externally.

(17) The detection system described in (16) characterized in that the change of the magnetic field is performed by moving a permanent magnet arranged in the vicinity of the member susceptible to magnetic influence or by magnetizing and de-magnetizing an electromagnet.

(18) The detection system described in (12) characterized in that the thickness of the space formed between the substrate and the concave portion provided on the cover member is from 20 micrometers to one millimeter.

(19) The detection system described in (12) characterized in that the magnitude of deformation of the cover member by the actuating unit is in the range from at least 20% to less than 100% of the thickness of the space.

(20) The detection system described in (12) characterized in that a plurality of the concave portions are provided on the cover member in order to form a plurality of spaces between the substrate and the concave portion provided on the cover member.

(21) The detection system described in (20) characterized in that, for the cover member having a plurality of the concave portions, the cover member on each concave portion is deformed by the actuating units that make contacts independently with the surfaces of each concave portion not facing the substrate.

(22) The detection system described in (20) characterized in that, for the plurality of spaces formed, the window portion is arranged corresponding to each of the spaces to detect the reaction.

(23) The detection system described in (20) characterized in that the cover member is made of a flexible and deformable resin material which can be quickly deformed in response to the shape of the actuating unit, the magnitude of its movement, the speed of its movement, and the like, and is preferably a silicone resin, an elastomer containing silicone, or a silicone rubber, and mixing of the solution retained in the space is carried out by deformation by the actuating unit.

(24) The detection system described in (12) characterized in that the target analyte is a single strand or double strand nucleic acid, antibody, antigen, receptor, ligand, or enzyme when the probe fixed on the substrate is a nucleic acid probe, antigen, antibody, ligand, receptor, or substrate, or the target analyte is a single strand nucleic acid or antibody when the tissue section is fixed on the substrate.

What is claimed is:

1. A solution mixing device comprising:
a substrate holder to hold a substrate where at least part of the surface of the substrate is fixed with at least a substance that binds specifically to at least a target analyte;
a cover member that faces the substrate holder and covers the substrate;
a liquid inlet to introduce a liquid between the substrate and the cover member;
a liquid outlet to discharge the liquid introduced between the substrate and the cover member; and
an actuating unit that makes contact with the cover member, wherein the actuating unit deforms at least part of the cover member.

2. The solution mixing device according to claim 1, wherein the cover member has a concave portion facing the substrate, and the actuating unit makes contact with the surface of the concave portion not facing the substrate.

3. The solution mixing device according to claim 1, wherein the actuating unit stirs the liquid introduced between the substrate and the cover member by deforming at least part of the cover member.

4. The solution mixing device according to claim 1, wherein the substance that binds specifically to the target analyte is a probe or a tissue section.

5. The solution mixing device according to claim 1, wherein the actuating unit is provided with a motor or an actuator.

6. The solution mixing device according to claim 2, wherein the actuating unit is a magnetically sensitive member attached to the surface of the concave portion not facing the substrate.

7. The solution mixing device according to claim 6, further comprising a magnetic field changing unit arranged in the vicinity of the magnetically sensitive member.

8. The solution mixing device according to claim 2, wherein the distance between the surface of the concave portion facing the substrate and the substrate is at least 20 micrometers and at most one millimeter.

9. The solution mixing device according to claim 2, wherein a plurality of the concave portions are provided on the cover member.

10. The solution mixing device according to claim 9, wherein a plurality of the actuating units are provided and the actuating units make contacts with the surfaces of the plurality of the concave portions not facing the substrate, respectively.

11. The solution mixing device according to claim 1, wherein the cover member is made of synthetic rubber or elastic rubber.

12. The solution mixing device according to claim 1, wherein the cover member is made of polydimethylsiloxane.

13. The solution mixing device according to claim 1, wherein the target analyte is a single strand or double strand nucleic acid, antibody, antigen, receptor, ligand, or enzyme when the substance that binds specifically to the target analyte is a nucleic acid probe, antigen, antibody, ligand, receptor, or substrate, or the target analyte is a single strand nucleic acid or antibody when the substance that binds specifically to the target analyte is a tissue section.

14. An analysis system comprising:
a substrate holder to hold a substrate where at least part of the surface of the substrate is fixed with at least a substance that binds specifically to at least a target analyte;
a cover member that faces the substrate holder and covers the substrate;
a liquid inlet to introduce a liquid between the substrate and the cover member;
a liquid outlet to discharge the liquid introduced between the substrate and the cover member;
a detection unit to detect a reaction between the target analyte and the substance that binds specifically to the target analyte; and
an actuating unit that makes contact with the cover member, wherein the actuating unit deforms at least part of the cover member.

15. The analysis system according to claim 14, wherein the substrate holder has a window portion and the detection unit detects the reaction through the window portion.

16. The analysis system according to claim 14, wherein the cover member has a concave portion facing the substrate, and the actuating unit makes contact with the surface of the concave portion not facing the substrate.

17. The analysis system according to claim 14, wherein the actuating unit stirs the liquid introduced between the substrate and the cover member by deforming at least part of the cover member.

18. The analysis system according to claim 16, wherein the distance between the surface of the concave portion facing the substrate and the substrate is at least 20 micrometers and at most one millimeter.

19. The analysis system according to claim 16, wherein a plurality of the concave portions and a plurality of the window portions are provided, and the window portions are arranged to each of the concave portions, respectively.

20. The analysis system according to claim 14, wherein the cover member is made of synthetic rubber or elastic rubber.
